(19) United States
(12) Patent Application Publication
(10) Pub. No.: US 2011/0210547 A1
(43) Pub. Date: Sep. 1, 2011

(54) PNEUMATIC MULTI-WAY CONNECTOR

(76) Inventor: Ian Malcolm Ryall, Hampshire (GB)

(21) Appl. No.: 13/129,043

(22) PCT Filed: Nov. 18, 2009
(86) PCT No.: PCT/GB2009/002692

§ 371 Date: May 12, 2011

(30) Foreign Application Priority Data
Nov. 18, 2008 (GB) 0821064.3

(51) Int. Cl. F16L 21/00

(52) U.S. Cl. 285/403

(57) ABSTRACT

A pneumatic multi-way connector has a cycling motor 1 and a cycling valve 2 for cycling pressure air from a non-shown pump to selected ducts 31, 32, 33, 34 in an outlet socket 3. The ducts are complementary to inlet ducts 41, 42, 43, 44 of an inlet plug 5. A ring cover encloses a rigid ring 16 which has a button 17 exposed at a top portion cover. A spring 18 biases the ring and the button upwards. The ring cover and the ring have a central opening 19 for receiving the disc 52 and the nose 55 of the cover 50 with the slots 56,57 aligned with the tabs 11,15. The plug is located radially around a peripheral engagement region 20 of the opening 19. The disc 52 has an upper latch lug 58, which engages behind a rib 59 integral with the plate 14. This is at the top of the peripheral engagement region 20. At the bottom of the zone, the disc has a lower latch lug 60, provided in two parts separated by the slot 56. This engages behind the bottom sector 61 of the ring 16. The ducts 31-34 are provided in a resilient member 35 captivated between the outlet plate 14 and a stator moulding 36 forming part of the cycling valve, which does not form part of the present invention and will not be further described save that it has a rotor 37 on the side of the stator remote from the resilient member. The bores terminate at the tubes 38 having deformable noses 39. These abut the disc 52 and form a seal therewith. Release of the plug, by depression of the button 17, allows the tubes and noses to recover, pushing the plug out to a position whence it falls down, this being the intention in the event of an emergency calling for disconnection and deflation of the mattress.

The present invention relates to a connector for a pneumatic multi-way connector for a pneumatic mattress.

In the event of cardiac arrest, a pneumatic mattress must be quickly and easily deflatable. For this they must be quickly and easily disconnectable from their pump.

The object of the present invention is to provide an improved pneumatic multi-way connector for a pneumatic mattress

According to the invention there is provided a pneumatic multi-way connector for a pneumatic mattress comprising:

a socket having a peripheral engagement region;

a complementarily formed plug engageable within the socket;
one or other or both of the plug and the socket being resilient or being provided with a resilient member for urging the plug and socket apart;
each of the socket and plug being formed with:
   a plurality of bores which are to be interconnected on connection of the plug with the socket, the bores having orifices opening at respective complementary abutment faces of the plug and socket,
   complementary fixed latch formations at one position around the engagement region and
   complementary disengageable latch formations at another position around the engagement region, one of the disengageable formations on either the socket or the plug being movable for disengagement of the other;
one of the plug and the socket being formed with a manually movable member connected to the movable latch formation for disengagement of the plug from the socket,

the arrangement being such that on movement of the movable member, the resilient plug, socket or member urges the plug out of the socket allowing deflation of the mattress.

Normally:
the socket will be fixedly connected to a source of pressure air in the form of a pump;
a cycling valve will be connected between the source and the sockets bores;
the resilient member will incorporate the bores of the plug or the socket and provide the abutment face of the plug or socket, although it is envisaged that the resilient member could be a resilient seal for all of the bores or one of a plurality of resilient seals for respective bores;
the fixed latch formations will be at a lower position around the engagement region with the disengageable formations at the top, although the opposite is envisaged to be practical;
the manually movable member will be provided on the socket, but it could be provided on the plug.
   These normal features can be provided collectively or separately.

Where the resilient member is provided in the socket, it can be a moulded member including connections to pressure sensor useful in monitoring operation of the pneumatic mattress.

In the preferred embodiment, the plug is provided at its abutment face with a disc including bore apertures, which are aligned with the plugs bores when the plug is engaged and are turnable to an out of alignment position should disconnection without mattress deflation be required.

To help understanding of the invention, a specific embodiment thereof will now be described by way of example and with reference to the accompanying drawings, in which:

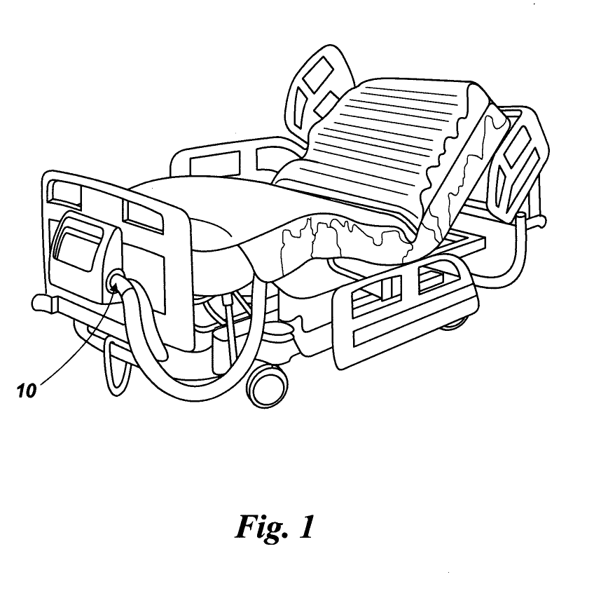

FIG. 1 is a perspective view of a bed having a pneumatic mattress and a pneumatic multi-way connector in accordance with the invention,

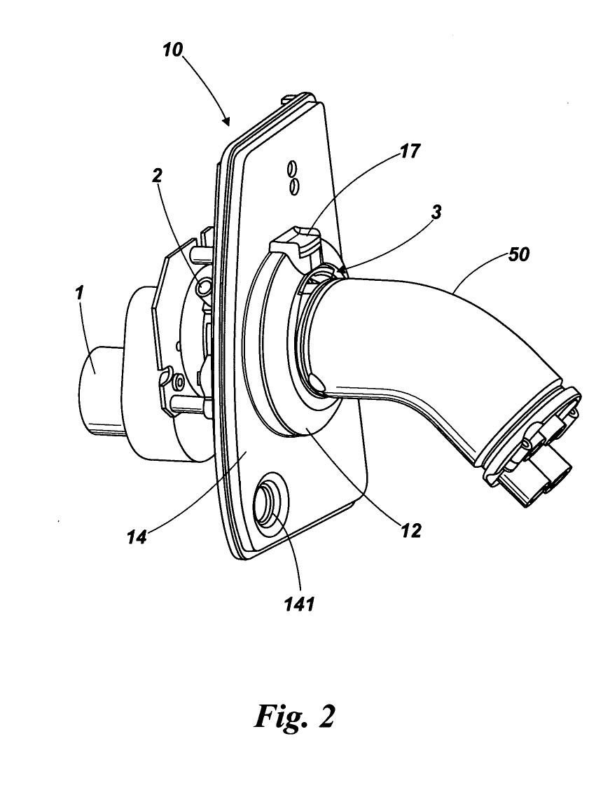

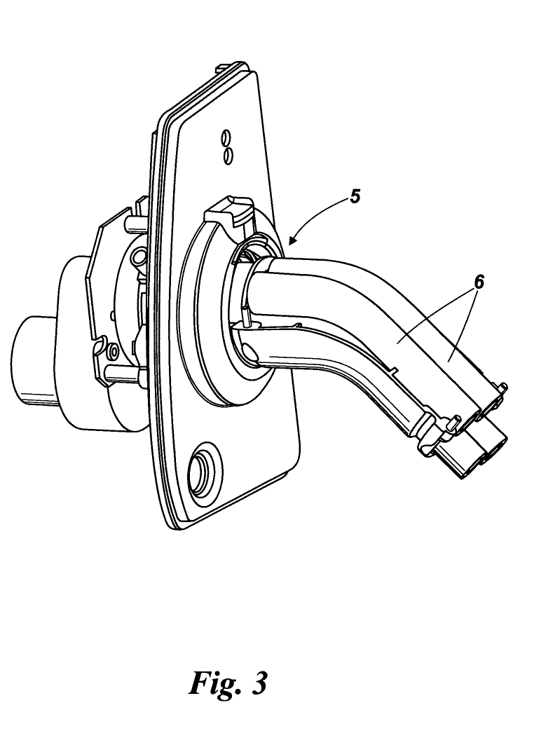

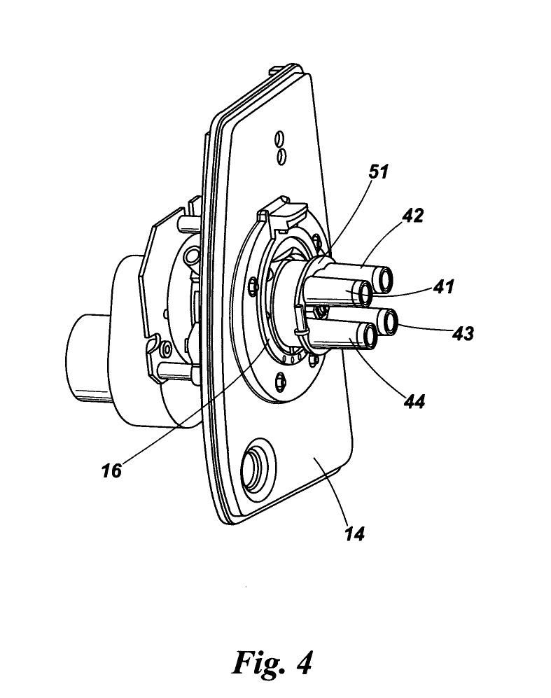

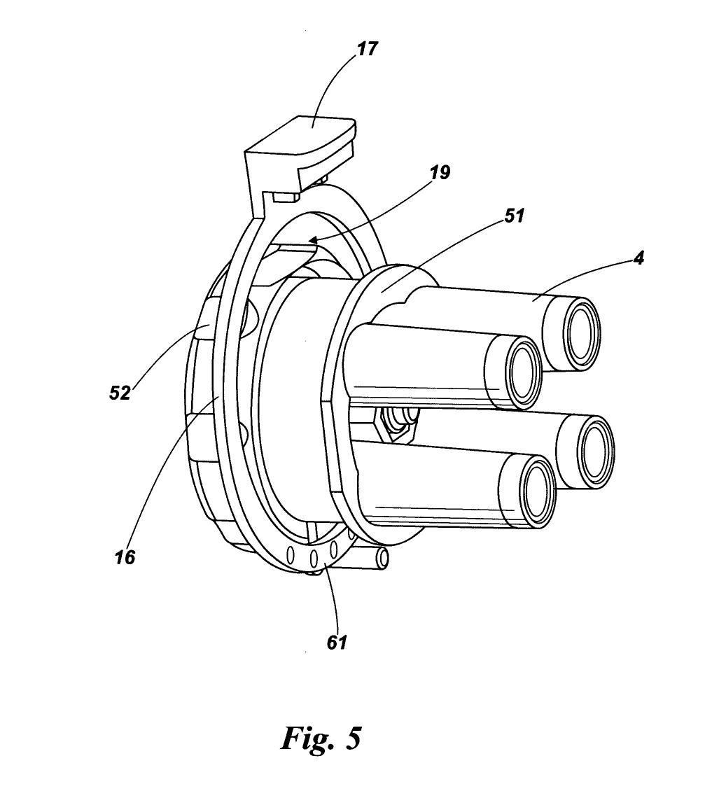

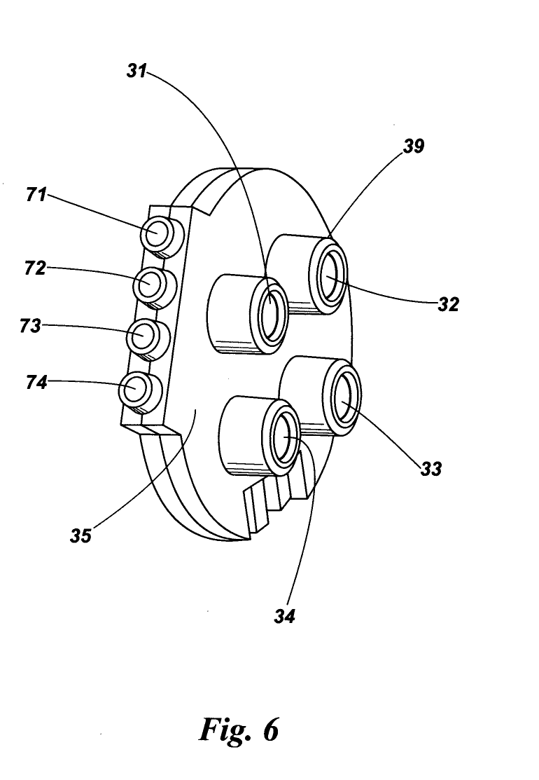

FIGS. 2 to 6 are similar perspective views, with outer part successively removed of the pneumatic multi-way connector of FIG. 1 and

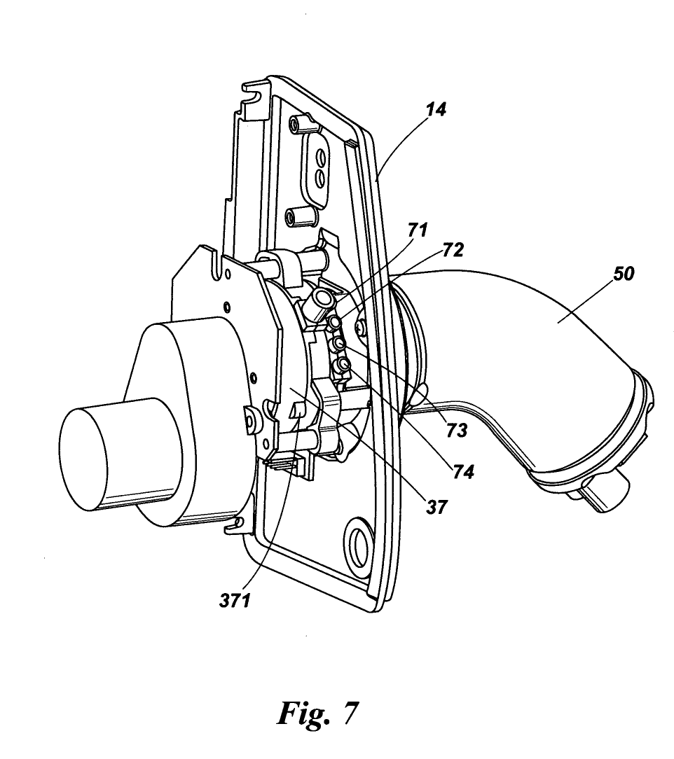

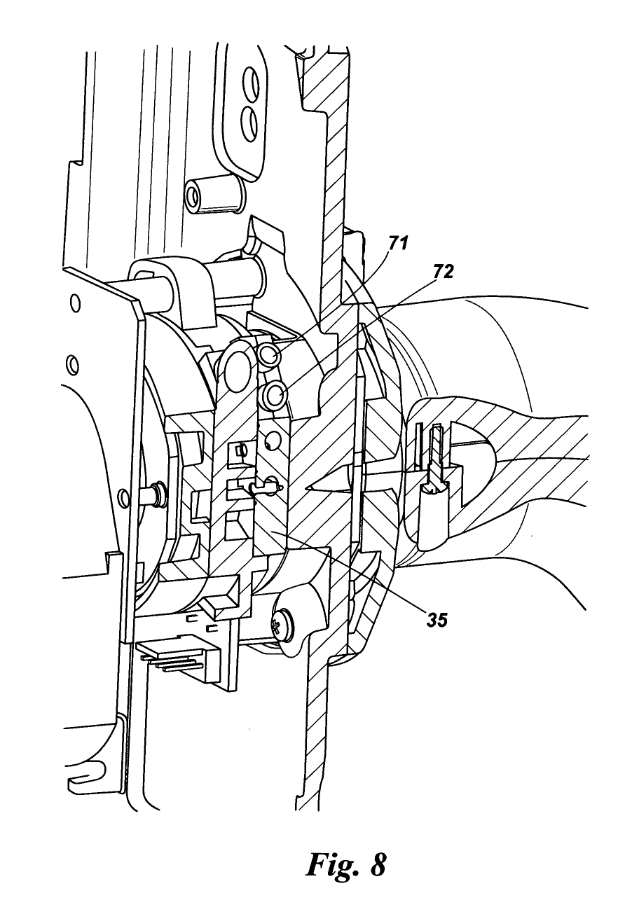

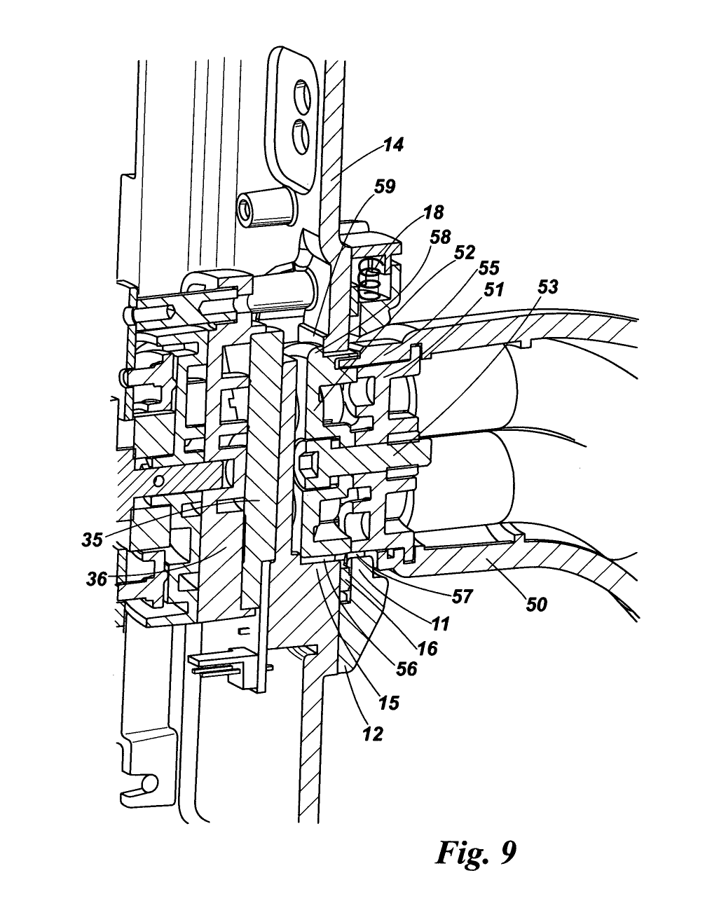

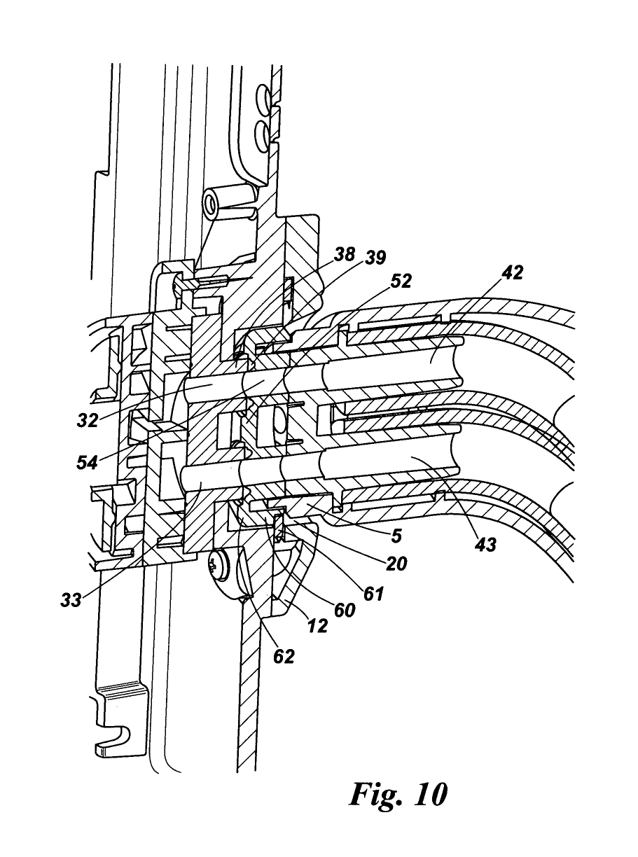

FIGS. 7 to 10 are perspective views from the same angle of the pneumatic multi-way connector at differing cross-sectional positions and differing scales.

Referring to the drawings, the pneumatic multi-way connector 10 has a cycling motor 1 and a cycling valve 2 for cycling pressure air from a non-shown pump to selected ducts 31, 32, 33, 34 in an outlet socket 3, the ducts being described below with reference to FIGS. 7 to 10. The ducts are complementary to inlet ducts 41, 42, 43, 44 of an inlet plug 5, these latter ducts being connected to individual pipes 6 of an umbilical hose and thence to cells of a pneumatic mattress—neither shown. A cover 50 surrounds an end of the ducts and the ends of the pipes.

The inlet plug 5 is in two parts, a main moulding 51, having the ducts, and a front disc 52. The main moulding is fast with the cover 50. The disc is connected to the moulding via a central bolt 53. The disc is rotatable to a limited extent to bring apertures 54 in the disk out of register with the ducts, whereby the umbilical connector can be set to a state maintaining inflation of its pneumatic mattress without connection to a source of pressure air.

When the disc is set for air communication and connection of the plug to the socket, two slots 56,57 in the disc 52 and the cover 50 respectively are aligned for receiving a tab 11 on a ring cover 12, which is fast with an outlet plate 14. The plate has a further tab 15, aligned with the tab 12. The ring cover encloses a rigid ring 16 which has a button 17 exposed at a top portion cover. A spring 18 biases the ring and the button upwards. The ring cover and the ring have a central opening 19 for receiving the disc 52 and the nose 55 of the cover 50 with the slots 56,57 aligned with the tabs 12,15. The plug is located radially around a peripheral engagement region 20 of the opening 19.

The disc 52 has an upper latch lug 58, which engages behind a rib 59 integral with the plate 14. This is at the top of the peripheral engagement region 20. At the bottom of the zone, the disc has a lower latch lug 60, provided in two parts separated by the slot 56. This engages behind the bottom sector 61 of the ring 16.

Engagement of the plug is effected by angling it slightly downwards and offering it into the opening. The upper lug 58 and rib 59 are first engaged. The plug is then swung down about the lug and rib acting as a pivot. This action brings a radiused corner 62 of the disc 52 into contact with the rigid ring 16, which is moved down until the lower lug 60 springs up to engage the lug. Removal is the reverse action, able to be initiated by depression of the ring via the button 17.

The ducts 31-34 are provided in a resilient member 35 captivated between the outlet plate 14 and a stator moulding 36 forming part of the cycling valve, which does not form part of the present invention and will not be further described save that it has a rotor 37 on the side of the stator remote from the resilient member. The rotor has a protrusion 371 for co-operation with a non-shown micro-switch for zeroing of the cycling valve. The bores terminate at the tubes 38 having deformable noses 39. These abut the disc 52 and form a seal therewith. Release of the plug, by depression of the button 17, allows the tubes and noses to recover, pushing the plug out to a position whence it falls down, this being the intention in the event of an emergency calling for disconnection and deflation of the mattress.

One final feature of note is that the resilient member has a series 71,72,73,74 of secondary bores in communication with the ducts 31-34. Sensors (not shown) can be connected to the secondary bores for monitoring the air pressure therein and thus in the relevant cells of the mattress.

The invention is not intended to be restricted to the details of the above described embodiment. The socket will normally be incorporated in a bed end control box. The cover 14 has a position 141 for a jacket socket enabling a head erection detector to communicator with circuitry in the box.

I claim:

1. A pneumatic, multi-way connector for a pneumatic mattress comprising:
a socket having a peripheral engagement region; and
a complementarily formed plug engageable within the socket;
wherein:
a one or other or both of the plug and the socket is resilient or is provided with a resilient member for urging the plug and socket apart;
each of the socket and plug is formed with:
a plurality of bores which are to be interconnected on connection of the plug with the socket, the bores having orifices opening at respective complementary abutment faces of the plug and socket,
complementary fixed latch formations at one position around the engagement region and
complementary disengageable latch formations at another position around the engagement region, one of the disengageable formations on either the socket or the plug being movable for disengagement of the other;
one of the plug and the socket is formed with a manually movable member connected to the movable latch formation for disengagement of the plug from the socket,
the arrangement being such that on movement of the movable member, the resilient plug, socket or member urges the plug out of the socket allowing immediate deflation of the mattress.

2. A pneumatic multi-way connector according to claim 1, wherein the resilient member is a resilient seal for all of the bores or one of a plurality of resilient seals for respective bores.

3. A pneumatic multi-way connector according to claim 1, wherein the resilient member incorporates the bores of the plug or the socket and provides the abutment face of the plug or socket incorporating the resilient member.

4. A pneumatic multi-way connector according to claim 3, wherein a cycling valve is connected to the socket's bores at the ends thereof remote from their orifices.

5. A pneumatic multi-way connector according to claim 4, wherein:
a the resilient member is a moulded member provided in the socket and
a the cycling valve has a stator sealingly abutting the resilient member and a rotor on its side remote from the resilient member.

6. A pneumatic multi-way connector according to claim 3, wherein the resilient member includes connections for pressure sensors for use in monitoring operation of the pneumatic mattress.

7. A pneumatic multi-way connector as claimed in according to claim 1, wherein the manually movable member is provided on the plug.

8. A pneumatic multi-way connector according to claim 1, wherein the manually movable member is provided on the socket.

9. A pneumatic multi-way connector according to claim 1, wherein the fixed latch formations are at a lower position around the engagement region with the disengageable formations at the top.

10. A pneumatic multi-way connector according to claim 1, wherein the fixed latch formations are at an upper position around the engagement region with the disengageable formations at the bottom.

11. A pneumatic multi-way connector according to claim 8, wherein
the manually movable member is provided on the socket; and
the manually movable member is provided at the top of the socket and is connected to a ring extending around the socket having the movable latch formation at its bottom.

12. A pneumatic multi-way connector according to claim 1, wherein the plug is provided at its abutment face with a disc including bore apertures, which are aligned with the plugs bores when the plug is engaged and are turnable to an out of alignment position should disconnection without mattress deflation be required.

13. A pneumatic multi-way connector according to claim 3, wherein the plug and the disc have formations alignable with a complementary formation on the socket for permitting engagement when the formations are aligned and hindering engagement when the formations are not aligned whereby engagement is possible only with pneumatic connection.

14. A pneumatic multi-way connector according to claim 1, wherein the socket is fixedly connected to a source of pressure air.

15. A pneumatic multi-way connector according to claim 4, wherein the resilient member includes connections for pressure sensors for use in monitoring operation of the pneumatic mattress.

16. A pneumatic multi-way connector according to claim 5, wherein the resilient member includes connections for pressure sensors for use in monitoring operation of the pneumatic mattress.
